(19) United States
(12) Patent Application Publication
(10) Pub. No.: US 2026/0244178 A1
(43) Pub. Date: Aug. 20, 2026

(54) METHODS AND AN INTERNET OF THINGS (IOT) SYSTEMS FOR VAPOR-LIQUID IDENTIFICATION BASED ON VORTEX FLOW SENSORS

(71) Applicant: CHENGDU QINCHUAN IOT TECHNOLOGY CO., LTD., Chengdu (CN)

(72) Inventors: Zehua SHAO, Chengdu (CN); Yong LI, Chengdu (CN); Chang SU, Chengdu (CN)

(73) Assignee: CHENGDU QINCHUAN IOT TECHNOLOGY CO., LTD., Chengdu (CN)

(21) Appl. No.: 19/641,513

(22) Filed: Apr. 7, 2026

(30) Foreign Application Priority Data
Mar. 19, 2026 (CN) 202610343052.1

(51) Int. Cl. G05B 15/02; G05D 23/30; G16Y 40/30

(52) U.S. Cl. CPC G05B 15/02; G05D 23/30; G16Y 40/30

(57) ABSTRACT

Disclosed are a method and an Internet of Things (IoT) system for vapor-liquid identification based on a vortex flow sensor. The method is implemented by a management platform of the IoT system for vapor-liquid identification based on the vortex flow sensor, the method including: determining a spectral feature of each location point based on vortex signal data of the each location point; determining a steam feature of the each location point based on the spectral feature of the each location point; determining at least one first location point based on the steam feature of the each location point, the at least one first location point including a location point where wet steam occurs; generating a dehumidification instruction based on a steam feature of the at least one first location point; and controlling a first automatic steam trap to adjust at least one of an opening degree or an opening frequency.

### CROSS-REFERENCE TO RELATED APPLICATIONS

This application claims priority to Chinese Application No. 202610343052.1, filed on March 19, 2026, the entire contents of which are incorporated herein by reference.

### TECHNICAL FIELD

The present disclosure generally relates to the field of industrial process automation and Internet of Things (IoT) monitoring, in particular to a method and an Internet of Things (IoT) system for vapor-liquid identification based on a vortex flow sensor.

### BACKGROUND

In industrial steam distribution systems, vortex flow sensors are widely used for steam flow measurement. However, when steam contains condensate to form wet steam, the wet steam not only affects accuracy of flow measurement, but also may cause a liquid slugging phenomenon, causing damage to pipelines and equipment. Currently, steam pipeline networks mostly rely on fixed strategies or manual experience for drainage management, lacking real-time perception and dynamic response capabilities to changes in vapor-liquid states.

Therefore, it is desirable to provide a method and an Internet of Things (IoT) system for vapor-liquid identification based on a vortex flow sensor. The method and the IoT system for vapor-liquid identification based on the vortex flow sensor can achieve accurate identification of the wet steam and can coordinate with execution mechanisms for active intervention, thereby improving safety and energy efficiency levels of steam system operation.

### SUMMARY

One or more embodiments of the present disclosure provide a method for vapor-liquid identification based on a vortex flow sensor. The method is implemented by a management platform of an IoT system for vapor-liquid identification based on a vortex flow sensor.

The method includes: determining a spectral feature of each location point based on vortex signal data of the each location point within a target pipeline network; determining a steam feature of the each location point based on the spectral feature of the each location point; determining at least one first location point based on the steam feature of the each location point, wherein the at least one first location point includes a location point where wet steam occurs; generating a dehumidification instruction based on a steam feature of the at least one first location point; and controlling a first automatic steam trap to adjust at least one of an opening degree or an opening frequency based on the dehumidification instruction.

One or more embodiments of the present disclosure provide an Internet of Things (IoT) system for vapor-liquid identification based on the vortex flow sensor. The IoT system includes a management platform and a perception and control platform. The management platform is configured to execute the method for vapor-liquid identification based on the vortex flow sensor.

One or more embodiments of the present disclosure provide a non-transitory computer-readable storage medium. The storage medium stores computer instructions, and when a computer reads the computer instructions in the storage medium, the computer executes the method for vapor-liquid identification based on the vortex flow sensor.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, wherein:

FIG. 1 is a schematic diagram illustrating an exemplary platform structure of an Internet of Things (IoT) system for vapor-liquid identification based on a vortex flow sensor according to some embodiments of the present disclosure;

FIG. 2 is a flowchart illustrating an exemplary method for vapor-liquid identification based on a vortex flow sensor according to some embodiments of the present disclosure;

FIG. 3 is a flowchart illustrating an exemplary process for determining a steam feature according to some embodiments of the present disclosure;

FIG. 4 is a schematic diagram illustrating an exemplary liquid slugging prediction model according to some embodiments of the present disclosure.

### DETAILED DESCRIPTION

To more clearly illustrate the technical solutions in the embodiments of the present disclosure, the accompanying drawings used in the description of the embodiments are briefly introduced below. It is obvious that the drawings in the following description are merely some examples or embodiments of the present disclosure. For a person of ordinary skill in the art, the present disclosure may be applied to other similar scenarios according to these drawings without creative efforts. Unless obviously obtained from the context or the context illustrates otherwise, the same numeral in the drawings refers to the same structure or operation.

It should be understood that the terms “system,” “apparatus,” “unit,” and/or “module” used herein are a method for distinguishing different components, elements, parts, sections, or assemblies at different levels. However, if other words may achieve the same purpose, the words may be replaced by other expressions.

As shown in the present disclosure and the claims, unless the context clearly indicates an exception, the words “a,” “an,” “one,” and/or “the” are not limited to the singular form, and may also include the plural form. Generally, the terms “comprising” and “including” only indicate inclusion of explicitly identified steps and elements. The steps and elements do not constitute an exclusive list. The method or apparatus may also include other steps or elements.

Flowcharts are used in the present disclosure to illustrate operations performed by the system according to the embodiments of the present disclosure. It should be understood that preceding or following operations are not necessarily performed precisely in order. On the contrary, each step may be processed in reverse order or simultaneously. At the same time, other operations may be added to the processes, or one or more steps may be removed from the processes.

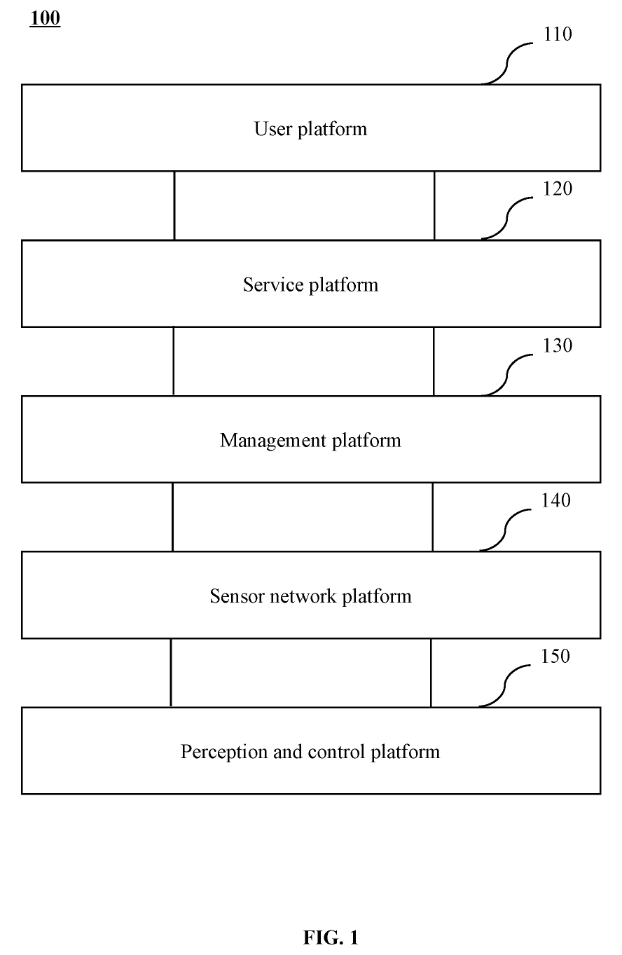

FIG. 1 is a schematic diagram illustrating an exemplary platform structure of an Internet of Things (IoT) system for vapor-liquid identification based on a vortex flow sensor according to some embodiments of the present disclosure.

In some embodiments, as shown in FIG. 1, the IoT system 100 for vapor-liquid identification based on the vortex flow sensor may include a user platform 110, a service platform 120, a management platform 130, a sensor network platform 140, and a perception and control platform 150.

The user platform 110 refers to a platform for interacting with a user.

In some embodiments, the user platform 110 is configured as a terminal or a server for use by the user, such as a smart mobile terminal, a computer, or the like.

The service platform 120 refers to a platform for conveying user requirements and control information.

In some embodiments, the service platform 120 is configured as a terminal or a server for communication.

In some embodiments, the service platform 120 may interact with the user platform 110 and the management platform 130.

The management platform 130 refers to a platform for implementing overall management of vapor-liquid identification.

In some embodiments, the management platform 130 is configured as a processor or a server that implements management functions.

The sensor network platform 140 refers to a platform that comprehensively manages sensor information of the entire system.

In some embodiments, the sensor network platform 140 is configured as a communication device, a gateway, or a server for communication.

In some embodiments, the sensor network platform 140 may interact with the management platform 130 and the perception and control platform 150.

The perception and control platform 150 refers to a functional platform for executing control information.

In some embodiments, the perception and control platform 150 is configured as hardware equipment required for executing vapor-liquid management, and may include a plurality of steam pipeline networks, automatic steam traps, heat tracing controllers, vortex flow sensors, or the like.

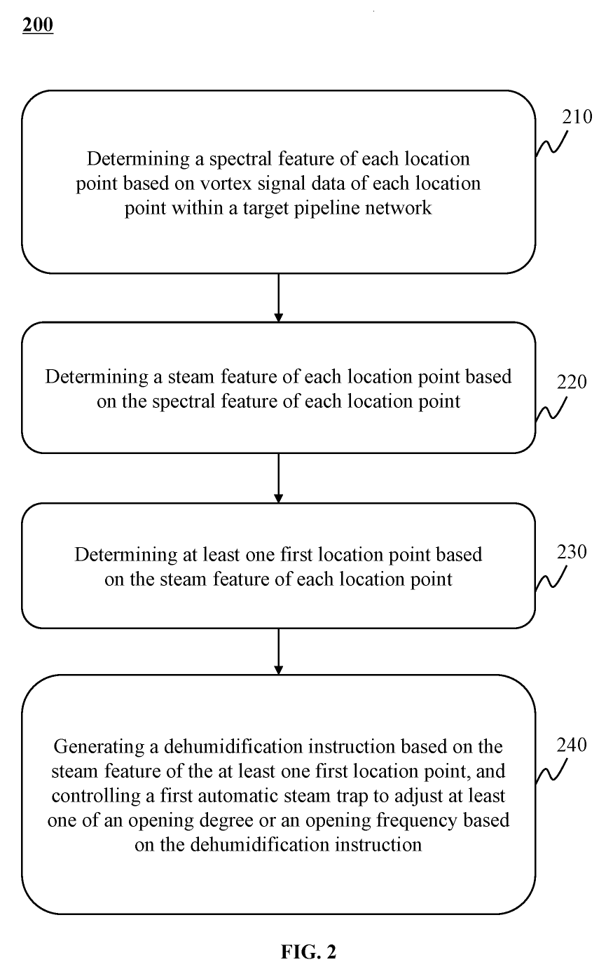

More descriptions may be found in the related descriptions of FIG. 2 to FIG. 4.

In some embodiments, the IoT system 100 for vapor-liquid identification based on the vortex flow sensor may form a closed loop of information operation among functional platforms, thereby achieving informatization and intelligence of vapor-liquid management. In some embodiments, an artificial intelligence (AI) model may be applied to the IoT model architecture to assist in data perception and processing.

FIG. 2 is a flowchart illustrating an exemplary method for vapor-liquid identification based on a vortex flow sensor according to some embodiments of the present disclosure. As shown in FIG. 2, a process 200 may include operations 210-240. In some embodiments, the process 200 may be implemented by the management platform (e.g., a processor corresponding to the management platform) of the IoT system for vapor-liquid identification based on the vortex flow sensor.

In 210, determining a spectral feature of each location point based on vortex signal data of each location point within a target pipeline network.

The target pipeline network refers to a steam pipeline network that requires monitoring and control. For example, the target pipeline network includes all steam pipeline networks of a chemical plant.

The location point refers to a location where the vortex flow sensor is deployed. For example, the location point includes a connection between a boiler and a steam outlet, a location on a steam pipeline (e.g., a relatively low location), and a connection between a steam inlet and a reaction kettle.

The vortex signal data refers to a high-frequency (e.g., 1024 Hz or 2048 Hz) time series signal that is collected by a piezoelectric crystal or a similar sensitive element disposed inside the vortex flow sensor and is unprocessed. For example, the vortex signal data includes a voltage or pressure vibration value sampled at a frequency of 2048 Hz.

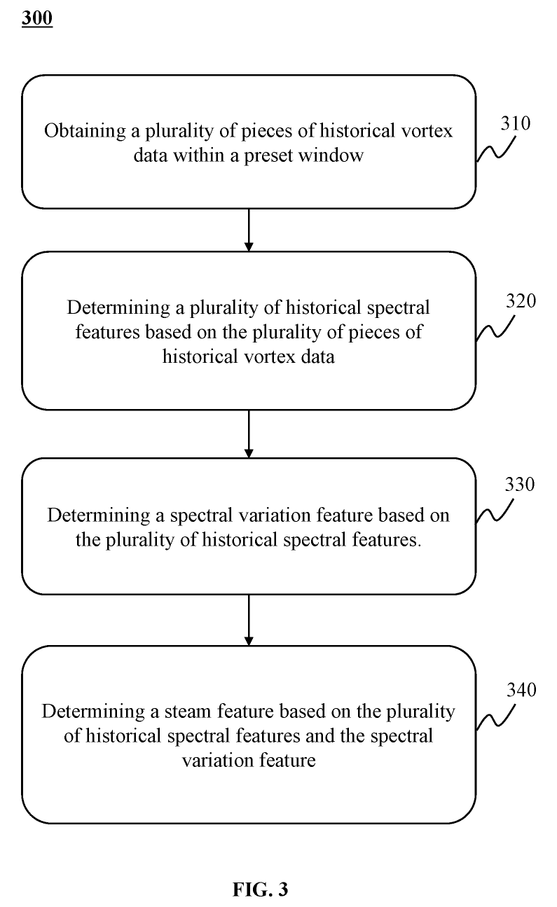

In some embodiments, the vortex signal data may include historical vortex data. More descriptions regarding the historical vortex data may be found in the present disclosure below (e.g., the related descriptions of FIG. 3).

In some embodiments, the management platform may be communicatively connected to the vortex flow sensor of the perception and control platform to obtain the vortex signal data of each location point within the target pipeline network from the vortex flow sensor at each location point within the target pipeline network.

The spectral feature refers to a feature extracted from a frequency domain representation of the vortex signal data that is capable of reflecting a steam state. For example, the spectral feature includes a peak amplitude, a mean value of spectral background noise, a main frequency dispersion, and an energy distribution entropy.

The peak amplitude refers to an amplitude value corresponding to a main frequency in a spectrum. The main frequency refers to a frequency point with a largest amplitude in a spectrum.

The mean value of spectral background noise refers to an average energy value of background noise in a spectrum excluding the main frequency and harmonics. For example, random impacts of liquid droplets significantly increase a noise level in a frequency range where the random impacts of the liquid droplets occur.

The main frequency dispersion refers to a statistical spread of fluctuations of a main frequency over time. The main frequency dispersion may be characterized by an energy concentration near a main frequency peak or a standard deviation of the main frequency peak. For example, interference from the liquid droplets causes the main frequency peak to become “diffuse” or “broadened”.

The energy distribution entropy refers to a measure of randomness or disorder of spectral energy distribution, and is used to characterize a degree of disorder of the spectral energy distribution. For example, an energy of dry steam is highly concentrated at the main frequency, and the energy distribution entropy of the dry steam is low; while an energy of the wet steam is distributed over a wide frequency range, and the energy distribution entropy of the wet steam is high.

In some embodiments, the spectral feature may include a historical spectral feature. More descriptions regarding the historical spectral feature may be found in the present disclosure below (e.g., the related descriptions of FIG. 3).

In some embodiments, the management platform may determine the spectral feature of each location point by performing a spectral analysis algorithm on the vortex signal data of each location point within the target pipeline network. For example, the management platform may perform the spectral analysis algorithm on the vortex signal data of each location point within the target pipeline network to obtain a frequency domain representation of the vortex signal data of each location point, and extract from the frequency domain representation of the vortex signal data of each location point to obtain the spectral feature of each location point.

In some embodiments, the spectral analysis algorithm may include a Fast Fourier Transform (FFT).

In 220, determining a steam feature of each location point based on the spectral feature of each location point.

The steam feature refers to a feature used to characterize a physical state, fluidity, or the like, of steam. For example, the steam feature includes a steam dryness and a flow pattern mode.

The steam dryness refers to a measure reflecting a dryness degree of the steam.

The flow pattern mode refers to a state of the steam. For example, the flow pattern mode may include a pure gas phase flow, a vapor-liquid slug flow, a vapor-liquid bubble flow, or the like.

In some embodiments, the steam feature may include a historical steam feature. More descriptions regarding the historical steam feature may be found in the present disclosure below.

In some embodiments, the management platform may determine the steam feature of each location point based on the spectral feature of each location point in a plurality of ways.

In some embodiments, the management platform may determine the steam feature of each location point based on the spectral feature of each location point through a spectral database. For example, the management platform may search in the spectral database based on the spectral feature of each location point, determine a historical spectral feature that is closest to (e.g., with a maximum vector similarity or a minimum vector distance or including the spectral feature of the corresponding location point) a spectral feature of a corresponding location point as a reference spectral feature, and determine a historical steam feature corresponding to the reference spectral feature as the steam feature of the corresponding location point.

The spectral database refers to a database for determining the steam feature. For example, the spectral database may include a database characterizing a correspondence relationship between the spectral feature and the steam feature. Merely by way of example, the spectral database includes a plurality of historical spectral features and historical steam features corresponding to the plurality of historical spectral features.

In some embodiments, the management platform may construct the spectral database based on historical data. The historical data may be stored in a built-in memory of the management platform. The historical data may include a plurality of historical spectral features of a plurality of different historical location points at a plurality of different moments, and the historical steam features corresponding to the plurality of historical spectral features.

In some embodiments, the management platform may construct a plurality of historical steam feature vectors based on the plurality of historical steam features. For example, elements of the plurality of historical steam feature vectors may include a historical steam dryness and a historical flow pattern mode. A first element of the historical steam feature vectors may be the historical steam dryness, and a second element of the historical steam feature vectors may be the historical flow pattern mode. Merely by way of example, a historical steam feature vector is (A, B), where A denotes a historical steam dryness and may be a percentage; B denotes a flow pattern mode, and values of B may include 1, 2, and 3, where 1 indicates that the historical flow pattern mode is the pure gas phase flow, 2 indicates that the historical flow pattern mode is the vapor-liquid slug flow, and 3 indicates that the historical flow pattern mode is the vapor-liquid bubble flow. The management platform may determine A and B based on corresponding historical steam features and historical spectral features in the historical data, respectively.

In some embodiments, the management platform may obtain a plurality of first clusters through a first clustering algorithm based on the plurality of historical steam feature vectors. A cluster center of each of the plurality of first clusters may represent a steam feature of a specific type. For example, a cluster center of a first cluster is (70%-90%, 1), indicating that the historical steam dryness is within a range of 70%-90% and the historical flow pattern mode is the pure gas phase flow. As another example, a cluster center of a first cluster is (50%-60%, 2), indicating that the historical steam dryness is within a range of 50%-60% and the historical flow pattern mode is the vapor-liquid slug flow.

In some embodiments, the first clustering algorithm may include, but is not limited to, a k-means clustering algorithm (K-means), density-based spatial clustering of applications with noise (DBSCAN), etc.

In some embodiments, the spectral database may include a plurality of cluster centers corresponding to the plurality of first clusters and labels corresponding to the plurality of cluster centers, respectively. A label corresponding to a cluster center of each of the plurality of first clusters may be determined based on the plurality of historical spectral features corresponding to the plurality of historical steam feature vectors included in the first cluster. For example, the label corresponding to the cluster center of each of the plurality of first clusters is a union of the historical spectral features corresponding to all historical steam feature vectors included in the first cluster.

In some embodiments, a reference spectral feature corresponding to the spectral feature of each location point is a spectral feature corresponding to the cluster center including the spectral feature of the location point, and the steam feature of each location point is the steam feature corresponding to the cluster center.

In some embodiments, the management platform is further configured to: for each location point, obtain a plurality of pieces of historical vortex data within a preset window; determine a plurality of historical spectral features based on the plurality of pieces of historical vortex data; determine a plurality of historical steam features based on the plurality of historical spectral features; and determine the steam feature through a state machine based on the plurality of historical steam features and the plurality of historical spectral features.

More descriptions regarding obtaining, for each location point, the plurality of pieces of historical vortex data within the preset window, and determining the plurality of historical spectral features based on the plurality of pieces of historical vortex data may be found in FIG. 3 and the related descriptions thereof.

The historical steam feature refers to a feature used for characterizing a physical state, fluidity, or the like, of historical steam corresponding to the historical vortex data. For example, the historical steam feature includes the historical steam dryness and the historical flow pattern mode.

The historical steam dryness refers to a measure reflecting the dryness degree of the historical steam.

The historical flow pattern mode refers to a state of the historical steam.

In some embodiments, the management platform may determine the historical steam feature of each location point through the spectral database based on the historical spectral feature of each location point. More descriptions regarding the spectral database may be found in the present disclosure above.

The state machine refers to a model used for determining the steam feature. For example, the state machine includes a finite-state machine (FSM).

In some embodiments, the management platform may determine the state machine through a second clustering algorithm based on the historical data.

In some embodiments, the management platform may determine the state machine for each location point within the target pipeline network.

In some embodiments, for each location point, the management platform may construct a plurality of state vectors based on the plurality of historical steam features and the plurality of historical spectral features of the location point. Each of the plurality of state vectors corresponds to a historical steam feature and a historical spectral feature of the location point at a specific historical moment.

For example, elements of a state vector may include the historical steam dryness, the historical flow pattern mode, a historical peak amplitude, a historical mean value of spectral background noise, a historical main frequency dispersion, and a historical energy distribution entropy. Merely by way of example, a state vector is (96%, 1, 0.5, 0.05, 2, 3), where 96% indicates that the historical steam dryness is 96%, 1 indicates that the historical flow pattern mode is the pure gas phase flow, 0.5 indicates that the historical peak amplitude is 0.5 V, 0.05 indicates that the historical mean value of spectral background noise is 0.05 V²/Hz, 2 indicates that the historical main frequency dispersion is 2 Hz, and 3 indicates that the historical energy distribution entropy is 3 bits.

In some embodiments, the management platform may obtain a plurality of second clusters by performing a second clustering algorithm based on the plurality of state vectors. Each of the plurality of second clusters may represent a specific state of the steam. For example, a second cluster (70%-90%, 1, 0.2-1, 0.01-0.1, 1-2, 1-3) means that the historical steam dryness is within a range of 70%-90%, the historical flow pattern mode is the pure gas phase flow, the historical peak amplitude is within a range of 0.2 V-1 V, the historical mean value of spectral background noise is within a range of 0.01 V²/Hz-0.1 V²/Hz, the historical main frequency dispersion is within a range of 1 Hz-2 Hz, and the historical energy distribution entropy is within a range of 1 bits-3 bits.

In some embodiments, the second clustering algorithm may include, but is not limited to, a k-means clustering algorithm (K-means), density-based spatial clustering of applications with noise algorithm (DBSCAN), etc.

In some embodiments, the management platform may determine a state evolution chain among the plurality of state vectors based on historical moments corresponding to the plurality of state vectors. For example, a time series is (t₁, t₂, ..., tₙ), where n is a positive integer. A moment t₁ corresponds to a state vector 1, a moment t₂ corresponds to a state vector 2, and a moment tₙ corresponds to a state vector n. Then the state evolution chain among the plurality of state vectors may be (state vector 1, state vector 2, ..., state vector n). The state evolution chain may represent a change of the steam feature and the spectral feature of the steam over time.

The management platform may determine a plurality of state evolution chains based on the plurality of state vectors, construct evolution relationships among the plurality of second clusters based on the plurality of state evolution chains, and obtain a state machine characterizing the evolution relationships among the plurality of second clusters for the location point.

In some embodiments, constructing the evolution relationships among the plurality of second clusters based on the plurality of state evolution chains includes: if a count of state vectors in a second cluster A pointing to state vectors in a second cluster B (or a count of state vectors in the second cluster A that evolve into state vectors in the second cluster B) is greater than a preset threshold, determining that the second cluster A and the second cluster B have an evolution relationship (evolving from the second cluster A to the second cluster B). The state vectors in the second cluster A pointing to the state vectors in the second cluster B refer to that the second cluster A develops into the second cluster B at a next moment.

The state machine may characterize evolution relationships among the plurality of second clusters. Evolutions among the plurality of second clusters in the state machine may be determined through an evolution condition (e.g., a trigger condition, a verification condition, and a confirmation condition). The evolution condition may be determined by at least one of the steam dryness, the flow pattern mode, the peak amplitude, the mean value of spectral background noise, the main frequency dispersion, or the energy distribution entropy corresponding to a cluster center of a second cluster after the second cluster evolves at a next moment.

For each location point, the management platform may determine the steam feature through the state machine based on the plurality of historical steam features and the plurality of historical spectral features of the location point.

For example, the management platform determines, through the state machine, whether a historical steam feature and a historical spectral feature of the location point at a specific moment satisfy a trigger condition. In response to the trigger condition being satisfied, the state machine enters a temporary verification state to determine, based on obtained data, whether a verification condition is satisfied. In response to the verification condition being satisfied, the state machine enters a confirmation state to determine, based on the obtained data, whether a confirmation condition is satisfied. In response to the trigger condition, the verification condition, and the confirmation condition being all satisfied within a first preset time, the management platform may output, through the state machine, the steam feature of the location point at a next moment of the specific moment. The first preset time may be preset by a technician.

The trigger condition refers to a condition of steam reflecting a potential anomaly. For example, the trigger condition may include at least one of the mean value of spectral background noise being higher than a first mean threshold for the first time, a spectral variation rate being greater than a variation rate threshold, a main frequency instability being greater than a baseline threshold, the steam dryness being less than a trigger threshold, etc. The first mean threshold, the variation rate threshold, the baseline threshold, and the trigger threshold may be preset by a technician. More descriptions regarding the spectral variation rate and the main frequency instability may be found in FIG. 3 and the related descriptions thereof.

The verification condition refers to a condition of steam detected after the trigger condition is satisfied, the condition constituting an evolution relationship with steam under a potential anomaly. For example, the verification condition may include deterioration of another steam feature or another spectral feature different from the trigger condition. Merely by way of example, the trigger condition is the mean value of spectral background noise being greater than the first mean threshold, and the verification condition includes the main frequency dispersion being greater than the dispersion threshold, or the energy distribution entropy being greater than an entropy threshold.

As another example, the verification condition may include further deterioration of the steam feature or the spectral feature in the trigger condition. Merely by way of example, the trigger condition is the mean value of spectral background noise being greater than the first mean threshold or the steam dryness being less than the trigger threshold, and the verification condition is the mean value of spectral background noise being greater than a second mean threshold or the steam dryness being less than a verification threshold. The second mean threshold may be greater than the first mean threshold. The verification threshold may be less than the trigger threshold.

As another example, the verification condition includes a duration of a state described by the trigger condition being greater than a duration threshold. The dispersion threshold, the entropy threshold, the second mean threshold, and the verification threshold may be preset by a technician.

The confirmation condition refers to a final condition for completing an entire evolution relationship. For example, the confirmation condition may include the steam feature or the spectral feature being greater than a confirmation threshold. Merely by way of example, the trigger condition is the mean value of spectral background noise being greater than the first mean threshold, the verification condition is the mean value of spectral background noise being greater than the second mean threshold, and the confirmation condition is the mean value of spectral background noise being greater than a third mean threshold, where the third mean threshold is greater than the second mean threshold.

As another example, the confirmation condition may include an amplitude of the main frequency peak dropping sharply to an unrecognizable level (e.g., a large amount of liquid droplets are mixed into gas, indicating that the vortex signal data is submerged by noise), a high-risk flow pattern mode appearing (e.g., a significant increase in energy of the vapor-liquid slug flow is detected using modal decomposition), or the steam dryness being less than the confirmation threshold, etc. The confirmation threshold and the third mean threshold may be preset by a technician.

The embodiments of the present disclosure enhance the ability to determine evolution processes of complex operation conditions by introducing the state machine to identify the evolution relationships among the plurality of historical steam features, thereby improving the reliability of determined steam features.

In 230, determining at least one first location point based on the steam feature of each location point.

The at least one first location point includes the location point where the wet steam occurs.

In some embodiments, the management platform may determine at least one first location point based on the steam feature of each location point. For example, the management platform may use a location point where the steam dryness is less than a preset dryness threshold, or the flow pattern mode is the vapor-liquid slug flow or the vapor-liquid bubble flow as the first location point.

In some embodiments, the preset dryness threshold may be preset by a technician based on experience.

In some embodiments, the wet steam may include steam of which the steam dryness is less than the preset dryness threshold, or the flow pattern mode is the vapor-liquid slug flow or the vapor-liquid bubble flow.

In 240, generating a dehumidification instruction based on the steam feature of the at least one first location point, and controlling a first automatic steam trap to adjust at least one of an opening degree or an opening frequency based on the dehumidification instruction.

The dehumidification instruction refers to an instruction for performing dehumidification on steam. For example, the dehumidification instruction may include increasing an opening degree of an automatic steam trap near the at least one first location point, and/or increasing an opening frequency of the automatic steam trap near the at least one first location point, where being near may be within a range of 1 m or 2 m from the at least one first location point.

The first automatic steam trap refers to an automatic steam trap closest to the at least one first location point.

The opening degree refers to a percentage of an opening area of the automatic steam trap to a maximum openable area.

The opening frequency refers to a count of complete cycles from closing to opening and then to closing completed by the automatic steam trap per unit time. An opening duty cycle refers to a proportion of opening time of the automatic steam trap in one cycle. For example, the opening frequency of 2 times/h, and the opening duty cycle of 50% indicate that the automatic steam trap completes 2 complete cycles within 1 h, a duration of each cycle is 0.5 h, and a duration for which the automatic steam trap remains open in each cycle is 15 min. The opening duty cycle may be preset by a technician. In some embodiments, opening duty cycles of different first location points may be the same or different.

In some embodiments, the management platform may generate the dehumidification instruction based on the steam feature of the at least one first location point. For example, the management platform may determine the dehumidification instruction based on the steam feature of the at least one first location point by querying a first preset table.

In some embodiments, each first location point may correspond to a first preset table. The first preset table characterizes the steam feature (e.g., the steam dryness and the flow pattern mode) of the first location point and the opening degree and the opening frequency of the first automatic steam trap corresponding to the first location point. For example, for a first location point, if the flow pattern mode is the vapor-liquid bubble flow or the vapor-liquid slug flow, the smaller the steam dryness, the larger the opening degree of the first automatic steam trap corresponding to the first location point, or the higher the opening frequency of the first automatic steam trap corresponding to the first location point. In some embodiments, the first preset table may be preset by a technician based on experience.

In some embodiments, the management platform may control the first automatic steam trap to adjust at least one of the opening degree or the opening frequency based on the dehumidification instruction to perform dehumidification on the at least one first location point. For example, if the steam dryness of a first location point is 40% and the flow pattern mode is the vapor-liquid bubble flow, the management platform obtains, by querying the first preset table of the first location point, that the opening degree of the first automatic steam trap corresponding to the first location point is 100% and the opening frequency is 5 times/min, and controls the first automatic steam trap to open at the opening frequency of 5 times/min and controls the first automatic steam trap to fully open at each opening; if the opening duty cycle of the first location point is 25%, a duration of each opening is 3s until the steam feature of the first location point reaches a preset condition.

The preset condition may include that the steam dryness is not less than the steam dryness threshold and the flow pattern mode is a preset flow pattern mode. The preset condition, the steam dryness threshold, and the preset flow pattern mode may be preset by a technician based on experience.

As another example, if the steam dryness of a first location point is 90% and the flow pattern mode is the pure gas phase flow, the management platform obtains, by querying the first preset table of the first location point, that the opening degree of the first automatic steam trap corresponding to the first location point is 40% and the opening frequency is 1 time/min, and controls the first automatic steam trap to open at the opening frequency of 1 time/min and controls the first automatic steam trap to open at the opening degree of 40% at each opening; if the opening duty cycle of the first location point is 10%, a duration of each opening is 6 s until the steam feature of the first location point reaches the preset condition.

The embodiments of the present disclosure perform spectral analysis on the vortex signal data to identify the location point where the wet steam occurs (i.e., the first location point), and control the corresponding automatic steam trap (e.g., the first automatic steam trap) to perform dehumidification, thereby achieving automated identification and removal of condensate water formed within the target pipeline network.

FIG. 3 is a flowchart illustrating an exemplary process for determining a steam feature according to some embodiments of the present disclosure. As shown in FIG. 3, a process 300 may include operations 310-340. In some embodiments, the process 300 may be performed by the management platform of the IoT system for vapor-liquid identification based on the vortex flow sensor.

In some embodiments, the management platform may perform operations corresponding to the process 300 for each location point, respectively. More descriptions regarding the location point may be found in FIG. 2 and the related descriptions thereof.

In 310, obtaining a plurality of pieces of historical vortex data within a preset window.

The preset window refers to a time period before a current moment. For example, the preset window may include a time period within previous 10 s or 15 s. The preset window may be obtained in a plurality of ways. For example, the preset window may be preset by a technician based on experience. As another example, in response to a spectral variation feature satisfying an early warning condition, the management platform may adjust the preset window. More descriptions regarding the spectral variation feature satisfying the early warning condition may be found in the present disclosure below.

The plurality of pieces of historical vortex data refers to vortex signal data collected at a plurality of moments within the preset window.

The management platform may obtain the plurality of historical vortex data within the preset window from the built-in memory.

In 320, determining a plurality of historical spectral features based on the plurality of pieces of historical vortex data.

The plurality of historical spectral features refer to features extracted from a frequency domain representation of the historical vortex data and capable of reflecting a steam state. For example, the plurality of historical spectral features include a historical peak amplitude, a historical mean value of spectral background noise, a historical main frequency dispersion, and a historical energy distribution entropy.

Determination of the historical spectral features may be similar to determination of the spectral feature. More descriptions regarding determining the spectral feature may be found in FIG. 2 and the related descriptions thereof.

In 330, determining a spectral variation feature based on the plurality of historical spectral features.

The spectral variation feature refers to a feature reflecting a variation trend of the spectral feature within the preset window. The spectral variation feature may include a spectral variation rate, a spectral instability, a spectral persistence, etc.

The spectral variation rate may include a linear regression slope or a difference rate of the spectral feature (e.g., the mean value of spectral background noise and the energy distribution entropy) within the preset window. The spectral variation rate may reflect a deterioration speed or an improvement speed of the wet steam.

The spectral instability may be characterized based on a standard deviation or a variance of the spectral feature (e.g., a peak amplitude) within the preset window. The spectral instability may include a main frequency instability. The spectral instability may reflect a fluctuation degree or a pulsation degree of the steam.

The spectral persistence may include a duration during which the mean value of spectral background noise is great than a preset mean value. The preset mean value may be preset by a technician based on experience. The spectral persistence may be configured to filter out transient interference in the historical spectral features to ensure effectiveness of the spectral variation rate.

In some embodiments, the management platform determines the spectral variation feature through mathematical calculation based on the plurality of historical spectral features.

Two situations are known: a situation where the spectral variation feature satisfies an early warning condition and a situation where the spectral variation feature does not satisfy the early warning condition. In some embodiments, in response to the spectral variation feature satisfying the early warning condition, the management platform may adjust the preset window.

The early warning condition refers to a condition for adjusting the preset window. For example, the early warning condition may include at least one of the spectral variation rate being greater than a first early warning threshold and the spectral instability being greater than a second early warning threshold. The early warning condition, the first early warning threshold, and the second early warning threshold may be preset by a technician based on experience.

In response to the spectral variation feature satisfying the early warning condition, the management platform may adjust the preset window. The management platform may adjust the preset window by shortening the preset window by a first preset proportion. The first preset proportion may be preset by a technician, such as 1/2, 1/5, etc.

In some embodiments, in response to the spectral variation feature not satisfying the early warning condition, the management platform may extend the preset window by a first preset multiple. The first preset multiple may be preset by a technician, such as 2, 5, etc.

The embodiments of the present disclosure can achieve rapid response to sudden risk events while ensuring stable system monitoring by dynamically adjusting the preset window when the early warning condition is satisfied.

In 340, determining a steam feature based on the plurality of historical spectral features and the spectral variation feature.

In some embodiments, for each location point, the management platform may determine the steam feature through the spectral database based on the plurality of historical spectral features and the spectral variation feature. The spectral database may include a database characterizing a correspondence relationship among the historical spectral features, the spectral variation feature, and the steam feature. For example, the management platform may determine the steam feature of each location point by searching in the spectral database based on the plurality of historical spectral features and the spectral variation feature of each location point.

In some embodiments, the management platform may construct the spectral database based on the historical data and the spectral variation feature.

In some embodiments, the spectral database may include a plurality of cluster centers corresponding to the plurality of first clusters and labels respectively corresponding to the plurality of cluster centers. A label corresponding to the cluster center of each of the plurality of first clusters may be determined based on a plurality of historical spectral features corresponding to the plurality of historical steam feature vectors included in the first cluster and spectral variation features corresponding to the plurality of historical spectral features. For example, the label corresponding to the cluster center of each of the plurality of first clusters is a union of the historical spectral features corresponding to all historical steam feature vectors included in the first cluster and a spectral variation feature corresponding to the union of the historical spectral features.

More descriptions regarding the spectral database may be found in FIG. 2 and the related descriptions thereof.

The embodiments of the present disclosure introduce the historical spectral features and the spectral variation feature to comprehensively analyze dynamic variation trends of steam states, thereby further improving the accuracy of steam feature identification.

It should be noted that the above descriptions regarding the process 200 and the process 300 are merely for examples and illustration and do not limit the applicable scope of the present disclosure. Various modifications and changes may be made to the process 200 and the process 300 by those skilled in the art under the guidance of the present disclosure. However, these modifications and changes are still within the scope of the present disclosure.

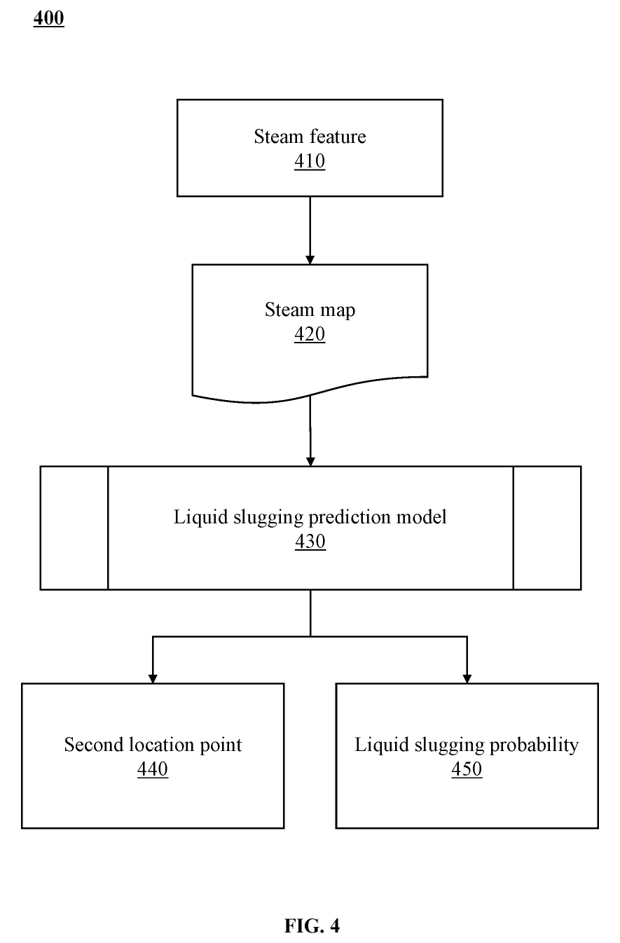

FIG. 4 is a schematic diagram illustrating an exemplary liquid slugging prediction model according to some embodiments of the present disclosure.

As shown in FIG. 4, in some embodiments, the management platform may be further configured to: construct a steam map 420 based on a steam feature 410 of each location point; determine at least one second location point 440 through a liquid slugging prediction model 430 based on the steam map, the liquid slugging prediction model being a machine learning model; and generate a heating instruction based on a steam feature of the at least one second location point, and send the heating instruction to a heat tracing controller of a perception and control platform, wherein the heating instruction includes a heating power and a heating period, and the heat tracing controller is configured to heat the at least one second location point at the heating power during the heating period based on the heating instruction.

The steam map refers to a directed graph structure of steam features and connection relationships of location points in a pipeline network, including a plurality of nodes and a plurality of directed edges.

The nodes of the steam map may correspond to an automatic steam trap, a confluence point, a diversion point, a critical steam-using device, or the like, in the pipeline network. Attributes of the nodes of the steam map may be steam features corresponding to the nodes. The critical steam-using device refers to an important terminal device in the steam pipeline network. For example, the critical steam-using device may include a heat exchanger, a steam boiler, a sterilizer, a dryer, or the like. The edges of the steam map may correspond to physical pipelines that connect the nodes, and directions of the edges may be determined by an actual flow direction of the steam. The attributes of the edges of the steam map may correspond to physical parameter attributes of the pipelines, such as a length, a pipe diameter, a pipe wall thickness, a material, an insulation condition, a slope, or the like. The physical parameter attributes of the pipelines may be obtained through design documents of the pipeline network, construction drawings, equipment records, on-site measurement data, or the like.

In some embodiments, the nodes of the steam map may further include a vortex sensor node corresponding to the vortex flow sensor, and a node feature of the vortex sensor node may include a spectral variation feature of the vortex flow sensor.

More descriptions regarding the spectral variation feature may be found in FIG. 2 and the related descriptions thereof.

In some embodiments of the present disclosure, the nodes of the steam map may include the vortex sensor node, and the node feature of the vortex sensor node may include the spectral variation feature. By incorporating information reflecting spectral dynamic evolution into a map representation, the liquid slugging prediction model can more accurately capture variation trends of steam states, thereby improving reliability and timeliness of prediction for the at least one second location point.

More descriptions regarding the location point and the steam feature may be found in FIG. 2 and the related descriptions thereof.

In some embodiments, the management platform may treat each vortex flow sensor, automatic steam trap, confluence point, diversion point, and key steam-using device in the pipeline network as the nodes, treat pipelines that connect the nodes as directed edges based on actual steam flow directions, and assign the steam feature attributes to the nodes and the physical parameter attributes of the pipelines to the edges, thereby constructing the steam map.

The at least one second location point refers to a location point where liquid slugging may occur within a future period. The future period refers to a period of time from a current moment onward. For example, the future period may be 10 s, 20 s, or the like.

The liquid slugging prediction model refers to a model for predicting a location point where liquid slugging may occur in the future.

In some embodiments, the liquid slugging prediction model is a machine learning model. For example, the liquid slugging prediction model may be a graph neural network (GNN) model, another custom model structure, or any combination thereof.

In some embodiments, an input of the liquid slugging prediction model may be the steam map, and an output of the liquid slugging prediction model may be at least one second location point.

In some embodiments, the management platform may input a constructed steam map into the liquid slugging prediction model, and the liquid slugging prediction model may analyze propagation and evolution trends of steam in the pipeline network based on the steam features of the nodes in the steam map and pipeline physical parameters characterized by the edges, thereby outputting one or more location points where liquid slugging may occur in the future period as the at least one second location point.

In some embodiments, the liquid slugging prediction model may be obtained by training a large number of first training samples with first training labels. The first training samples may be a plurality of historical steam maps, and the first training labels may be at least one location point where liquid slugging occurs in historical pipeline networks corresponding to the first training samples during a subsequent period of historical moments corresponding to the first training samples.

In some embodiments, the first training samples may be obtained by collecting historical vortex data of the steam pipeline network at a plurality of historical moments and constructing corresponding steam maps based on the steam feature of each location point and a pipeline network structure. The first training labels may be obtained by recording one or more location points where liquid slugging actually occurs within a preset period after the historical moments.

In some embodiments, the liquid slugging prediction model may perform a plurality of iterations, where at least one of the plurality of iterations includes: the management platform inputting one or more first training samples with first training labels into an initial liquid slugging prediction model to obtain outputs corresponding to the one or more first training samples, substituting the outputs of the initial liquid slugging prediction model and actual corresponding first training labels into a predefined loss function to calculate a value of the loss function, and performing iterative updating on the initial liquid slugging prediction model based on the loss function (e.g., performing iterative updating based on a gradient descent algorithm); when the value of the loss function satisfies an iteration completion condition, completing training and obtaining a trained liquid slugging prediction model. The iteration completion condition may include convergence of the loss function, a count of iterations reaching a threshold, or the like.

In some embodiments, the output of the liquid slugging prediction model may further include a liquid slugging probability 450 of the at least one second location point. The management platform may be further configured to: determine one or more pre-drainage points based on the at least one second location point; and generate a pre-drainage instruction based on the liquid slugging probability of the at least one second location point and the one or more pre-drainage points, and send the pre-drainage instruction to a second automatic steam trap of the perception and control platform, the second automatic steam trap being configured to adjust at least one of an opening degree or an opening frequency based on the pre-drainage instruction.

The liquid slugging probability refers to a probability of liquid slugging occurring at the at least one second location point.

In some embodiments, the first training labels may include a liquid slugging probability of one or more location points (hereinafter referred to as one or more sample second location points) where liquid slugging actually occurs within the preset period after the historical moments in the first training samples. The liquid slugging probability of the one or more sample second location points may be determined based on a time difference between a moment when liquid slugging occurs at the one or more sample second location points and the historical moments corresponding to the first training samples and a plurality of confidence intervals:

In response to the time difference between the moment when liquid slugging occurs at the one or more sample second location points and the historical moments corresponding to the first training samples being within a confidence interval (e.g., a duration corresponding to the time difference being within a maximum duration of the confidence interval), taking the confidence interval of 15 min as an example, i.e., liquid slugging occurs within 0-15 min after the historical moments, it is determined that a probability of liquid slugging occurring at the at least one second location point is a first set value. The first set value may be a relatively high value preset manually based on experience. For example, the first set value may be 75%, 80%, 90%, or the like.

In response to the time difference (e.g., the time difference being 20 min) between the moment when liquid slugging occurs at the at least one second location point and the historical moments corresponding to the first training samples being greater than a duration of one confidence interval but less than a duration of two confidence intervals, it is determined that a probability of liquid slugging occurring at the at least one second location point is a second set value. The second set value may be a moderate value preset manually based on experience. For example, the second set value may be 55%, 60%, or 70%. The first set value may be greater than the second set value.

In response to the time difference (e.g., the time difference being 35 min) between the moment when liquid slugging occurs at the at least one second location point and the historical moments corresponding to the first training samples being greater than a duration of two confidence intervals, it is determined that a probability of liquid slugging occurring at the at least one second location point is a third set value. The third set value may be set manually based on experience. For example, the third set value may be 10%, 20%, or 25%. The confidence interval may be set manually based on experience. For example, a duration of the confidence interval may be any other suitable value, such as 5 min, 10 min, or the like.

The pre-drainage point refers to a point that requires dehumidification. The pre-drainage point may be a point corresponding to the second automatic steam trap.

The second automatic steam trap refers to an automatic steam trap for executing the pre-drainage instruction. For example, the second automatic steam trap may be one or more automatic steam traps located upstream of the at least one second location point.

In some embodiments, for each second location point, the management platform may use N automatic steam traps closest upstream of each second location point as the second automatic steam traps and use locations corresponding to the second automatic steam traps as the pre-drainage points.

The pre-drainage instruction refers to a drainage instruction for controlling the automatic steam trap to open at a small opening degree or for a short period of time. The pre-drainage instruction may include the opening frequency and the opening degree. The small opening degree refers to the opening degree of the automatic steam trap not greater that a first threshold. For example, the opening degree is not greater than 10%. The short period of time refers to a single opening duration not greater than a second threshold. For example, the single opening duration of the valve is not greater than 5 s. The first threshold and the second threshold may be set manually based on experience.

In some embodiments, the management platform may determine at least one of the opening degree or the opening frequency of the second automatic steam trap based on the liquid slugging probability of the at least one second location point and a corresponding pre-drainage point to generate the pre-drainage instruction. The management platform may send the pre-drainage instruction to the second automatic steam trap of the perception and control platform.

In some embodiments, for each second location point, the management platform may determine the opening degree and the opening frequency of a corresponding second automatic steam trap through a third preset table based on the liquid slugging probability and the one or more pre-drainage points. The third preset table refers to a mapping relationship table for determining the opening degree and the opening frequency of the automatic steam trap. The third preset table includes a mapping relationship among the liquid slugging probability, the opening frequency, and the opening degree. For example, the higher the liquid slugging probability, the larger the opening degree, and the higher the opening frequency. The third preset table may be preset based on experience.

In some embodiments, the automatic steam trap may adjust the opening degree each time the automatic steam trap opens based on a received pre-drainage instruction and perform periodic opening and closing operations based on a specified opening frequency.

In some embodiments of the present disclosure, the liquid slugging probability output by the liquid slugging prediction model is used for generating the pre-drainage instruction. The management platform controls the second automatic steam trap to perform a drainage operation at the small opening degree for a short period of time based on the liquid slugging probability and the pre-drainage point upstream of the at least one second location point, thereby implementing preventive drainage upstream of high-risk regions without significantly affecting steam distribution efficiency, and reducing the possibility of liquid slugging.

By utilizing the liquid slugging probability output by the liquid slugging prediction model, the management platform can identify high-risk second location points and perform pre-drainage operations on the second automatic steam trap upstream thereof at the small opening degree or for a short period of time, thereby removing scattered condensate droplets accumulated in the pipelines in advance at an extremely low steam loss cost, effectively blocking formation conditions of liquid slugs, and significantly improving active prevention capability against liquid slugging.

In some embodiments, for each second location point, the management platform may determine the steam feature of the second location point in the following manner. If the second location point is provided with the vortex flow sensor, a steam feature corresponding to the vortex signal data collected by the vortex flow sensor is directly used as the steam feature of the second location point; if the second location point is not provided with the vortex flow sensor, a spectral feature corresponding to one or more location points, where the vortex flow sensor is provided, that are closest upstream and downstream of the second position point, is obtained, the spectral feature of the second location point is estimated through a linear interpolation algorithm, and the steam feature is determined through a correspondence relationship between the spectral feature and the steam feature based on the spectral database.

More descriptions regarding the spectral database may be found in FIG. 2 and the related descriptions thereof.

The heating instruction refers to a control instruction for controlling the heat tracing controller to heat a target location point. The heating instruction may include a heating power and a heating period.

The heating power refers to a power of the heat tracing controller during heating.

The heating period refers to a period during which the heat tracing controller performs heating. The heating period may be preset based on an operation time of the steam pipeline network. Heating periods corresponding to different location points may be the same or different.

The heat tracing controller refers to a device for controlling heating of the steam pipeline network. In some embodiments, for each second location point, a heat tracing controller closest to the second location point may be used as a heat tracing controller to be regulated.

In some embodiments, the management platform may generate the heating instruction through a second preset table based on the steam feature of the at least one second location point.

The second preset table refers to a mapping relationship table for determining the heating power and the heating period. The second preset table may include a mapping relationship among a steam dryness, a flow pattern mode, and a corresponding heating power and heating period. The lower the steam dryness and the closer the flow pattern mode is to vapor-liquid slug flow, i.e., the higher the liquid phase content of the steam, the higher the heating power and the longer the duration of the heating period. In some embodiments, the second preset table may be set manually based on experience.

In some embodiments, the management platform may send the generated heating instruction to the heat tracing controller of the perception and control platform. After receiving the heating instruction, the heat tracing controller may heat the at least one second location point based on the heating power and a heating duration specified in the heating instruction within the heating period specified by the heating instruction.

In some embodiments of the present disclosure, the steam map is constructed based on the steam feature of each location point, and the steam map is input into the liquid slugging prediction model. The liquid slugging prediction model can identify one or more second location points where liquid slugging is likely to occur in the future. Since the steam map uses sensors, steam traps, and other equipment in the pipeline network as the nodes and establishes connection relationships based on the pipeline physical parameters, the model can perform risk propagation analysis based on an overall pipeline network structure and a current state, thereby achieving early identification of locations that do not yet show obvious wet steam but have potential risks.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended for those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure, or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures, or characteristics may be combined as suitable in one or more embodiments of the present disclosure.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose and that the appended claims are not limited to the disclosed embodiments, but, on the contrary, are intended to cover modifications and equivalent arrangements that are within the spirit and scope of the disclosed embodiments. For example, although the implementation of various parts described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

In some embodiments, numbers describing the count of ingredients and attributes are used. It should be understood that such numbers used for the description of the embodiments use the modifier "about", "approximately", or "substantially" in some examples. Unless otherwise stated, "about", "approximately", or "substantially" indicates that the number is allowed to vary by ±20%. Correspondingly, in some embodiments, the numerical parameters used in the description and claims are approximate values, and the approximate values may be changed according to the required characteristics of individual embodiments. In some embodiments, the numerical parameters should consider the prescribed effective digits and adopt the method of general digit retention. Although the numerical ranges and parameters used to confirm the breadth of the range in some embodiments of the present disclosure are approximate values, in specific embodiments, settings of such numerical values are as accurate as possible within a feasible range.

For each patent, patent application, patent application publication, or other materials cited in the present disclosure, such as articles, books, specifications, publications, documents, or the like, the entire contents of which are hereby incorporated into the present disclosure as a reference. The application history documents that are inconsistent or conflict with the content of the present disclosure are excluded, and the documents that restrict the broadest scope of the claims of the present disclosure (currently or later attached to the present disclosure) are also excluded. It should be noted that if there is any inconsistency or conflict between the description, definition, and/or use of terms in the auxiliary materials of the present disclosure and the content of the present disclosure, the description, definition, and/or use of terms in the present disclosure is subject to the present disclosure.

Finally, it should be understood that the embodiments described in the present disclosure are only used to illustrate the principles of the embodiments of the present disclosure. Other variations may also fall within the scope of the present disclosure. Therefore, as an example and not a limitation, alternative configurations of the embodiments of the present disclosure may be regarded as consistent with the teachings of the present disclosure. Accordingly, the embodiments of the present disclosure are not limited to the embodiments introduced and described in the present disclosure explicitly.

What is claimed is:

1. An Internet of Things (IoT) system for vapor-liquid identification based on a vortex flow sensor, comprising a management platform and a perception and control platform, wherein the management platform is configured to:
determine a spectral feature of each location point based on vortex signal data of the each location point within a target pipeline network;
determine a steam feature of the each location point based on the spectral feature of the each location point;
determine at least one first location point based on the steam feature of the each location point, wherein
the at least one first location point includes a location point where wet steam occurs; and
generate a dehumidification instruction based on a steam feature of the at least one first location point, and send the dehumidification instruction to a first automatic steam trap of the perception and control platform, wherein
the first automatic steam trap is configured to adjust at least one of an opening degree or an opening frequency based on the dehumidification instruction.

2. The IoT system according to claim 1, wherein the management platform is further configured to:
for the each location point,
obtain a plurality of pieces of historical vortex data within a preset window;
determine a plurality of historical spectral features based on the plurality of pieces of historical vortex data;
determine a spectral variation feature based on the plurality of historical spectral features; and
determine the steam feature based on the plurality of historical spectral features and the spectral variation feature.

3. The IoT system according to claim 2, wherein the management platform is further configured to:
adjust the preset window in response to the spectral variation feature satisfying an early warning condition.

4. The IoT system according to claim 1, wherein the management platform is further configured to:
for the each location point,
obtain a plurality of pieces of historical vortex data within a preset window;
determine a plurality of historical spectral features based on the plurality of pieces of historical vortex data;
determine a plurality of historical steam features based on the plurality of historical spectral features; and
determine the steam feature through a state machine based on the plurality of historical steam features and the plurality of historical spectral features.

5. The IoT system according to claim 1, wherein the management platform is further configured to:
construct a steam map based on the steam feature of the each location point;
determine at least one second location point through a liquid slugging prediction model based on the steam map, wherein
the liquid slugging prediction model is a machine learning model; and
generate a heating instruction based on a steam feature of the at least one second location point, and send the heating instruction to a heat tracing controller of the perception and control platform, wherein
the heating instruction includes a heating power and a heating period, and
the heat tracing controller is configured to heat the at least one second location point at the heating power during the heating period based on the heating instruction.

6. The IoT system according to claim 5, wherein
the steam map includes a plurality of nodes, the plurality of nodes include vortex sensor nodes, and a node feature of the vortex sensor nodes includes a spectral variation feature.

7. The IoT system according to claim 5, wherein
an output of the liquid slugging prediction model includes a liquid slugging probability of the at least one second location point;
the management platform is further configured to:
determine one or more pre-drainage points based on the at least one second location point; and
generate a pre-drainage instruction based on the liquid slugging probability of the at least one second location point and the one or more pre-drainage points, and send the pre-drainage instruction to a second automatic steam trap of the perception and control platform, wherein
the second automatic steam trap is configured to adjust at least one of an opening degree or an opening frequency based on the pre-drainage instruction.

8. A method for vapor-liquid identification based on a vortex flow sensor, implemented by a management platform of an Internet of Things (IoT) system for vapor-liquid identification based on a vortex flow sensor, comprising:
determining a spectral feature of each location point based on vortex signal data of the each location point within a target pipeline network;
determining a steam feature of the each location point based on the spectral feature of the each location point;
determining at least one first location point based on the steam feature of the each location point, wherein
the at least one first location point includes a location point where wet steam occurs;
generating a dehumidification instruction based on a steam feature of the at least one first location point; and
controlling a first automatic steam trap to adjust at least one of an opening degree or an opening frequency based on the dehumidification instruction.

9. The method according to claim 8, wherein
the determining a spectral feature of each location point based on vortex signal data of the each location point within a target pipeline network includes:
for the each location point,
obtaining a plurality of pieces of historical vortex data within a preset window; and
determining a plurality of historical spectral features based on the plurality of pieces of historical vortex data; and
the determining a steam feature of the each location point based on the spectral feature of the each location point includes:
for the each location point,
determining a spectral variation feature based on the plurality of historical spectral features; and
determining the steam feature based on the plurality of historical spectral features and the spectral variation feature.

10. The method according to claim 9, further comprising:
adjusting the preset window in response to the spectral variation feature satisfying an early warning condition.

11. The method according to claim 8, further comprising:
for the each location point,
obtaining a plurality of pieces of historical vortex data within a preset window;
determining a plurality of historical spectral features based on the plurality of pieces of historical vortex data;
determining a plurality of historical steam features based on the plurality of historical spectral features; and
determining the steam feature through a state machine based on the plurality of historical steam features and the plurality of historical spectral features.

12. The method according to claim 8, further comprising:
constructing a steam map based on the steam feature of the each location point;
determining at least one second location point through a liquid slugging prediction model based on the steam map, wherein
the liquid slugging prediction model is a machine learning model;
generating a heating instruction based on a steam feature of the at least one second location point, wherein
the heating instruction includes a heating power and a heating period; and
controlling a heat tracing controller to heat the at least one second location point at the heating power during the heating period based on the heating instruction.

13. The method according to claim 12, wherein
the steam map includes a plurality of nodes, the plurality of nodes include vortex sensor nodes, and a node feature of the vortex sensor nodes includes a spectral variation feature.

14. The method according to claim 12, wherein
an output of the liquid slugging prediction model includes a liquid slugging probability of the at least one second location point; and
the method further comprises:
determining one or more pre-drainage points based on the at least one second location point;
generating a pre-drainage instruction based on the liquid slugging probability of the at least one second location point and the one or more pre-drainage points; and
controlling a second automatic steam trap to adjust at least one of an opening degree or an opening frequency based on the pre-drainage instruction.

15. A non-transitory computer-readable storage medium, wherein the storage medium stores computer instructions, and when a computer reads the computer instructions in the storage medium, the computer executes the method for vapor-liquid identification based on the vortex flow sensor of claim 8.
